(19) United States
(12) Patent Application Publication
(10) Pub. No.: US 2003/0021004 A1
(43) Pub. Date: Jan. 30, 2003

(54) Method for fabricating a through-wafer optical MEMS device having an anti-reflective coating

(76) Inventors: Shawn Jay Cunningham, Colorado Springs, CO (US); Svetlana Tatic-Lucic, Colorado Springs, CO (US); Dana R. DeReus, Colorado Springs, CO (US)

Correspondence Address: JENKINS & WILSON, PA, 3100 TOWER BLVD, SUITE 1400, DURHAM, NC, 27707, US

(21) Appl. No.: 10/025,182

(22) Filed: Dec. 19, 2001

Related U.S. Application Data
(60) Provisional application No. 60/256,604, filed on Dec. 19, 2000.
(60) Provisional application No. 60/256,607, filed on Dec. 19, 2000.
(60) Provisional application No. 60/256,610, filed on Dec. 19, 2000.
(60) Provisional application No. 60/256,611, filed on Dec. 19, 2000.
(60) Provisional application No. 60/256,683, filed on Dec. 19, 2000.
(60) Provisional application No. 60/256,688, filed on Dec. 19, 2000.
(60) Provisional application No. 60/256,689, filed on Dec. 19, 2000.
(60) Provisional application No. 60/256,674, filed on Dec. 20, 2000.
(60) Provisional application No. 60/260,558, filed on Jan. 9, 2001.

(51) Int. Cl. G02B 26/00

(52) U.S. Cl. 359/290; 359/291; 359/292

(57) ABSTRACT

An optical MEMS device is fabricated in either a surface or bulk micromachining process wherein an integral process step entails providing an antireflective coating on one or more surfaces of a substrate through which optical information is to be transmitted. In one method, a surface micromachining process is carried out in which a sacrificial layer is formed and patterned on an optically transmissive substrate. A structural layer is formed on the sacrificial layer and fills in regions of the sacrificial layer that have been removed. An amount of the sacrificial layer is removed sufficient to define and release a microstructure and thereby render the microstructure movable for interaction with an optical signal directed toward the optically transmissive substrate. In another method, a bulk micromachining process is carried out in which a first substrate is provided that is composed of an optically transmissive material. An antireflective coating is deposited on a major surface of the first substrate to enable an optical signal to be transmitted along a path directed through the antireflective coating and the first substrate. A movable, actuatable microstructure is formed a second substrate. The first and second substrates are aligned and bonded together in a manner enabling the microstructure to interact with the optical signal upon actuation of the microstructure.

### RELATED APPLICATIONS

This application claims the benefit of U.S. Provisional Patent Application Serial Nos. 60/256,604, filed Dec. 19, 2000; 60/256,607, filed Dec. 19, 2000; 60/256,610, filed Dec. 19, 2000; 60/256,611 filed Dec. 19, 2000; 60/256,683, filed Dec. 19, 2000; 60/256,688 filed Dec. 19, 2000; 60/256,689, filed Dec. 19, 2000; 60/256,674, filed Dec. 20, 2000; and 60/260,558, filed Jan. 9, 2001, the disclosure of which is incorporated herein by reference in its entirety.

### TECHNICAL FIELD

The present invention relates to MEMS fabrication technology. More specifically, the present invention relates to methods for fabricating a through-wafer optical MEMS device exhibiting low light loss through a substrate coated with an anti-reflective coating.

### BACKGROUND ART

Micro-optical-electro-mechanical systems (MOEMS, or optical MEMS) are being investigated and developed for their potential to improve optics-based systems, such as CDMA encoders and decoders, by reducing the cost and component size of such systems as well as to increase their functionality and programmability. In particular, optical shutters and other types of microstructures are being considered as means for interacting with an optical path to implement switching or attenuating functions. Shutter architectures can be based on either through-die or across-die solutions. In through-die architectures, the shutter can be actuated to interrupt an optical path from passing through the thickness of a wafer, whereas in across-die architectures, a shutter can be actuated to interrupt an optical path from passing across a surface of a wafer.

As appreciated by persons skilled in the art, many types of MEMS structures and devices can be fabricated by either bulk or surface micromachining techniques. Bulk micromachining generally involves sculpting one or more sides of a substrate to form desired three-dimensional structures and devices in the same substrate material. The substrate is composed of a material that is readily available in bulk form, and thus ordinarily is silicon or glass. Wet and/or dry etching techniques are employed in association with etch masks and etch stops to form the microstructures. Etching is typically performed through the backside of the substrate. The etching technique can generally be either isotropic or anisotropic in nature. Isotropic etching is insensitive to the crystal orientation of the planes of the material being etched (e.g., the etching of silicon by using a nitric acid as the etchant). Anisotropic etchants, such as potassium hydroxide (KOH), tetramethyl ammonium hydroxide (TMAH), and ethylenediamine pyrochatechol (EDP), selectively attack different crystallographic orientations (e.g., <100> and <111>) at different rates, and thus can be used to define relatively accurate sidewalls in the etch pits being created. Etch masks and etch stops are used to prevent predetermined regions of the substrate from being etched.

Surface micromachining, on the other hand, generally involves forming three-dimensional structures by depositing a number of different thin films on the top of a silicon wafer, but without sculpting the wafer itself. The films usually serve as either structural or sacrificial layers. Structural layers are frequently composed of polysilicon, silicon nitride, silicon dioxide, silicon carbide, or aluminum. Sacrificial layers are frequently composed of polysilicon, photoresist material, or various kinds of oxides, such as PSG (phosphosilicate glass) and LTO (low-temperature oxide). Successive deposition, etching, and patterning procedures are carried out to arrive at the desired microstructure. In a typical surface micromachining process, a silicon substrate is coated with an isolation layer, and a sacrificial layer is deposited on the coated substrate. Windows are opened in the sacrificial layer, and a structural layer is then deposited and etched. The sacrificial layer is then selectively etched to form a free-standing microstructure such as a beam or a cantilever out of the structural layer. The microstructure is ordinarily anchored to the silicon substrate, and can be designed to be movable in response to an input from an appropriate actuating mechanism.

An example of a micromachining process for fabricating a MEMS VOA is disclosed in U.S. Pat. No. 6,275,320. A base substrate is provided that consists of a single-crystal silicon substrate on which an oxide layer and an upper single-crystal silicon layer are formed. The upper silicon layer is then patterned using a mask to define a MEMS actuator, optical shutter, and other actuator and attenuator components. A dry etch process is used to remove regions of the upper silicon layer to form the components. A time-dependent wet etch process is used to remove the oxide layer and release the components, but not the shutter. A doping process is then implemented to render one or more of the components conductive. Surfaces of the shutter are metallized to provide a mirror capable of deflecting an optical beam. A backside etch process is then used to etch through the silicon base substrate and the remaining oxide layer, thereby releasing the shutter.

One proposed solution to providing an optical MEMS device with a through-die architecture entails providing an aperture through which the optical signal can be transmitted. Unfortunately, existing processes for fabricating apertures and complex, requiring custom-made features and non-standard process steps. Moreover, apertures have in the past tended to make the wafer of the optical MEMS device fragile and caused low yields in scaled-up fabrication.

It is acknowledged within the art that there remains an ongoing need for further improvements in bulk and surface micromachining techniques for fabricating through-die architectures and, in particular, architectures that do not rely on the fabrication of optical apertures.

### DISCLOSURE OF THE INVENTION

According to the present invention, a method is provided for fabricating an optical MEMS device wherein an antireflective coating is deposited as an integral part of the overall fabrication process. At the same time, the integration of the antireflection coating steps of the invention are independent of the overall process flow, although it is acknowledged that specific compositions for the antireflective coatings can depend on the substrates utilized in the process. The invention enables the transmission of optical information though the substrate and/or lid of an optical MEMS device, instead of being limited to transmission of optical information along a direction parallel to the substrate of the MEMS device, and hence avoids the limitations inherent in the operation of across-wafer designs. Moreover, the invention in use is believed to be superior to the conventional mode of operation in which optical information is transmitted to and from the same surface in a pure reflection mode. An optical MEMS device fabricated in accordance with the present invention, with antireflective coatings, provides the optical interface instead of relying on any package associated with the device to provide all optical interfaces, therefore simplifying any packaging process carried out.

The method of the present invention encompasses fabricating a through-wafer optical MEMS device by forming a movable, actuatable microstructure and at least one layer having an optically transmissive thickness and one or more antireflective (AR) coatings. The present invention utilizes one or more starting substrates, through a novel combination of surface and/or bulk micromachining processes involving material-adding, masking, patterning, and etching steps generally available in the IC and/or MEMS industries. In addition, known doping techniques such as diffusion and ion implantation can be used to render certain desired structural layers of the invention conductive, when it is desired to utilize such layers as, for example actuation electrodes, contacts, or interconnects.

The substrate or bulk layer through which optical information is permitted to pass can be any number of optical materials generally considered suitable in micromachining processes. Suitable examples include glass, quartz, sapphire, zinc oxide, silicon (in single-crystal, polycrystalline or amorphous forms), silica, alumina, or one of the various Group Ill-V compounds in either binary, ternary or quaternary forms (e.g., GaAs, InP, GaN, AlN, AlGaN, InGaAs, and so on). These materials can also be selected for the substrate or structural layers used to form a microstructure that is to control the transmission of optical information through the optical layer in accordance with the invention.

Silicon is readily available in boule or wafer form from commercial sources. The conductivity of the silicon layer or layers can be modulated by performing known methods of impurity doping. The various forms of silicon oxides (e.g., SiO₂, SiOₓ, and silicate glass) can be used as structural, insulating, or etch-stop layers. As known in the art, these oxides can be preferentially etched in hydrofluoric acid (HF) to form desired profiles. Various methods for adding oxide material to a substrate are known in the art. For example, silicon dioxide can be thermally grown by oxidizing silicon at high temperatures, in either a dry or wet oxidation process. Oxides and glasses, including phosphosilicate glass (PSG), borosilicate glass (BSG), borophosphosilicate glass (BPSG, also termed low-temperature oxide or LTO), as well as silicon-based thin films, can be deposited by chemical vapor deposition (CVD), including atmospheric pressure CVD (APCVD), low-pressure CVD (LPCVD) and low-temperature plasma-enhanced CVD (PECVD), as well as by physical vapor deposition (PVD) such as sputtering, or in some cases by a spin-on process similar to that used to deposit polymers and photoresists. Both stoichiometric and non-stoichiometric silicon nitride (SiₓN_{y}) can used as an insulating film, or as a masking layer in conjunction with an alkaline etch solution, and is ordinarily deposited by a suitable CVD method.

Contacts, interconnects, and light reflectors of various metals formed according to the methods of the invention are typically deposited by sputtering, CVD, or evaporation. If gold, nickel or Permalloy™ (NiₓFe_{y}) is selected as the metal element, an electroplating process can be carried out to transport the material to a desired surface. The chemical solutions used in the electroplating of various metals are generally known. Some metals, such as gold, might require an appropriate intermediate adhesion layer to prevent peeling. Examples of adhesion material often used include chromium, titanium, or an alloy such as titanium-tungsten (TiW).

Conventional lithographic techniques can be employed in accordance with the micromachining steps of the invention. Accordingly, basic lithographic process steps such as photoresist application, optical exposure, and the use of developers are not described in detail herein.

Similarly, generally known etching processes can be employed in accordance with the invention to selectively remove material or regions of material. An imaged photoresist layer is ordinarily used as a masking template. A pattern can be etched directly into the bulk of a substrate, or into a thin film or layer that is then used as a mask for subsequent etching steps.

As appreciated by those skilled in the art, the type of etching process employed in a particular process step described hereinbelow (e.g., wet, dry, isotropic, anisotropic, anisotropic-orientation dependent), the etch rate and the type of etchant used, will depend on the composition of material to be removed, the composition of any masking or etch-stop layer to be used, and the profile of the etched region to be formed. As examples, poly-etch (HF:HNO₃:CH₃COOH) can generally be used for isotropic wet etching. Hydroxides of alkali metals (e.g., KOH), simple ammonium hydroxide (NH₄OH), quaternary (tetramethyl) ammonium hydroxide ((CH₃)₄NOH, also known commercially as TMAH), and ethylenediamine mixed with pyrochatechol in water (EDP) can be used for anisotropic wet etching to fabricate V-shaped or tapered grooves, trenches or cavities. Silicon nitride is typically used as the masking material against etching by KOH, and thus can used in conjunction with the selective etching of silicon. Silicon dioxide is slowly etched by KOH, and thus can be used as a masking layer if the etch time is short. While KOH will etch undoped silicon, heavily doped (p++) silicon can be used as an etch-stop against KOH as well as the alkaline etchants and EDP. Silicon oxide and silicon nitride can be used as masks against TMAH and EDP. The preferred metal used to form contacts and interconnects in accordance with the invention is gold, which is resistant to EDP. The adhesion layer applied in connection with forming a gold component (e.g., chromium) is also resistant to EDP.

It will be appreciated that electrochemical etching in hydroxide solution can be performed instead of timed wet etching. For example, if a p-type silicon wafer is used as a substrate, an etch-stop can be created by epitaxially growing an n-type silicon end layer to form a p-n junction diode. A voltage is applied between the n-type layer and an electrode disposed in the solution to reverse-bias the p-n junction. As a result, the bulk p-type silicon is etched through a mask down to the p-n junction, stopping at the n-type layer. Also suitable are the more recently developed photovoltaic and galvanic etch-stop techniques, which are also based on the use of p-n junctions.

In addition, dry etching techniques such as plasma-phase etching and reactive ion etching (RIE) can be used to remove silicon and its oxides and nitrides, as well as various metals. Deep reactive ion etching (DRIE) can be used to anisotropically etch deep, vertical trenches in bulk layers. Silicon dioxide is typically used as an etch-stop against DRIE, and thus structures containing a buried silicon dioxide layer, such as silicon-on-insulator (SOI) wafers, can be used according to the methods of the invention as starting substrates for the fabrication of microstructures.

According to at least one method of the invention described hereinbelow, a first substrate is coated with an AR coating, a second substrate is used to fabricate one or more microstructures to interact with optical signals directed through the thickness of the coated first substrate, and the two substrates are at some stage bonded together to complete an optical MEMS device. A number of different bonding techniques can be implemented for this purpose. For example, anodic bonding can be used to join a silicon substrate to many types of glass substrates, as well as to join glass-to-glass and silicon-to-silicon. Fusion bonding can be used to join two silicon substrates. In bonding silicon-to-silicon by either fusion bonding or anodic bonding, an intermediate silicon dioxide layer is normally interposed between the two silicon substrates. Hence, SOI starting wafers are typically produced by fusion bonding. In accordance with the invention, one of the silicon bulk layers of an SOI starting wafer can, after micromachining steps are performed to partially or completely form a microstructure, be bonded to a second, aperture-containing silicon wafer through the use of fusion bonding. Other suitable bonding techniques include glass-frit bonding (low-temperature glass bonding of silicon-to-silicon, with a boron glass interlayer), eutectic bonding (silicon-to-silicon, with a gold interlayer), and adhesive bonding (e.g., the gluing of silicon-to-silicon, silicon-to-glass, or glass-to-glass, using spin-on adhesives). Since many types of bonding techniques are successful only at a high bonding temperature, the choice of a suitable technique might be limited if certain metallization steps are carried out prior to the bonding step. Otherwise, the bonding step should be conducted before the forming of metal components when possible. In order to align one substrate to another substrate so that a microstructure can properly interface with an aperture, conventional precision alignment techniques (e.g., the use of spacers and clamping fixtures) can be employed if needed.

According to one method of the present invention, an optical MEMS device is fabricated according to the following steps. An antireflective coating is deposited on a major surface of an optically transmissive substrate to enable an optical signal to be transmitted along a path directed through the antireflective coating and the substrate. A movable, actuatable microstructure is formed the substrate, thereby enabling the microstructure to interact with the optical signal upon actuation of the microstructure.

Preferably, a second antireflective coating is formed on the other, opposing major surface of the substrate.

According to one aspect of this method, a surface micromachining process is carried out in which a sacrificial layer is formed on the substrate. The sacrificial layer is patterned such that a portion of the substrate is exposed. The exposed portion of the substrate can include the antireflective coating, or in other cases the antireflective coating could be removed in this exposed area. A structural layer is formed on the sacrificial layer and fills in regions of the sacrificial layer that have been removed. Preferably a filled portion defines an anchor portion, and could also define standoff features if desired. An amount of the sacrificial layer is removed sufficient to release the microstructure and thereby render the microstructure movable and, preferably, actuatable by a suitable actuator mechanism.

According to another method of the present invention, an optical MEMS device is fabricated by the following steps. A first substrate is provided that is composed of an optically transmissive material in the desired bandwidth for the light to be used. An antireflective coating is deposited on a major surface of the first substrate to enable an optical signal to be transmitted along a path directed through the antireflective coating and the first substrate. A movable, actuatable microstructure is formed a second substrate. The first and second substrates are aligned and bonded together in a manner enabling the microstructure to interact with the optical signal upon actuation of the microstructure.

According to one aspect of this method, a conductive element is formed on the first substrate to serve as a contact or an interconnect. A channel is formed in the second substrate. An insulating layer can be deposited on the inside surfaces of this channel. When the first and second substrates are bonded together, the conductive element formed on the first substrate is disposed within the channel and is isolated from conductive regions of the resulting optical MEMS device.

The present invention also provides optical MEMS devices that are fabricated according to the methods of the present invention as described and claimed herein.

It is therefore an object of the present invention to provide a method for fabricating an optical MEMS device in which one or more antireflective coatings are applied to a substrate as part of the overall bulk or surface micromachining process used to fabricate the device.

It is another object of the present invention to provide a method for fabricating an optical MEMS device that includes an integral process step wherein a low-loss transmission layer or substrate is provided.

It is yet another object of the present invention to provide an optical MEMS device that is structured to control transmission of an optical signal through the device without the use of optical apertures in the substrate of the device.

Some of the objects of the invention having been stated hereinabove and which are achieved in whole or in part by the present invention, other objects will become evident as the description proceeds when taken in connection with the accompanying drawings as best described hereinbelow.

### BRIEF DESCRIPTION OF THE DRAWINGS

FIGS. 1A-1J are cross-sectional views illustrating various stages of a surface micromachining process for fabricating an optical MEMS device in accordance with one method of the present invention;

FIGS. 2A and 2B are cross-sectional views of a substrate coated with anti-reflective layers according to a bulk micromachining process provided by the present invention;

FIGS. 3A-3C are cross-sectional views of another substrate from which a microstructure is formed in accordance with the bulk micromachining process of the present invention;

FIG. 4 is a cross-sectional view illustrating the final stages of the bulk micromachining process of the present invention, including the bonding of the substrate illustrated in FIGS. 2A and 2B to the substrate illustrated in FIGS. 3A-3C; and

FIG. 5 is a cross-sectional view of an exemplary optical MEMS device fabricated based on any of the methods of the present invention.

### DETAILED DESCRIPTION OF THE INVENTION

For purposes of the present disclosure, it will be understood that when a given component such as a layer, region or substrate is referred to herein as being disposed or formed “on” another component, that given component can be directly on the other component or, alternatively, intervening components (for example, one or more buffer or transition layers, interlayers, electrodes or contacts) can also be present. It will be further understood that the terms “disposed on” and “formed on” are used interchangeably to describe how a given component is positioned or situated in relation to another component. Hence, the terms “disposed on” and “formed on” are not intended to introduce any limitations relating to particular methods of material transport, deposition, or fabrication.

Terms relating to crystallographic orientations, such as Miller indices and angles in relation to the plane of a layer of material, are intended herein to cover not only the exact value specified (e.g., (116), 45° and so on) but also any small deviations from such exact value that might be observed.

As used herein, the term “epitaxy” generally refers to the formation of a single-crystal film structure on top of a crystalline substrate, and could encompass both homoepitaxy and heteroepitaxy.

As used herein, the term “device” is interpreted to have a meaning interchangeable with the term “component.”

As used herein, the term “conductive” is generally taken to encompass both conducting and semi-conducting materials.

Examples of the methods of the present invention will now be described with reference to the accompanying drawings.

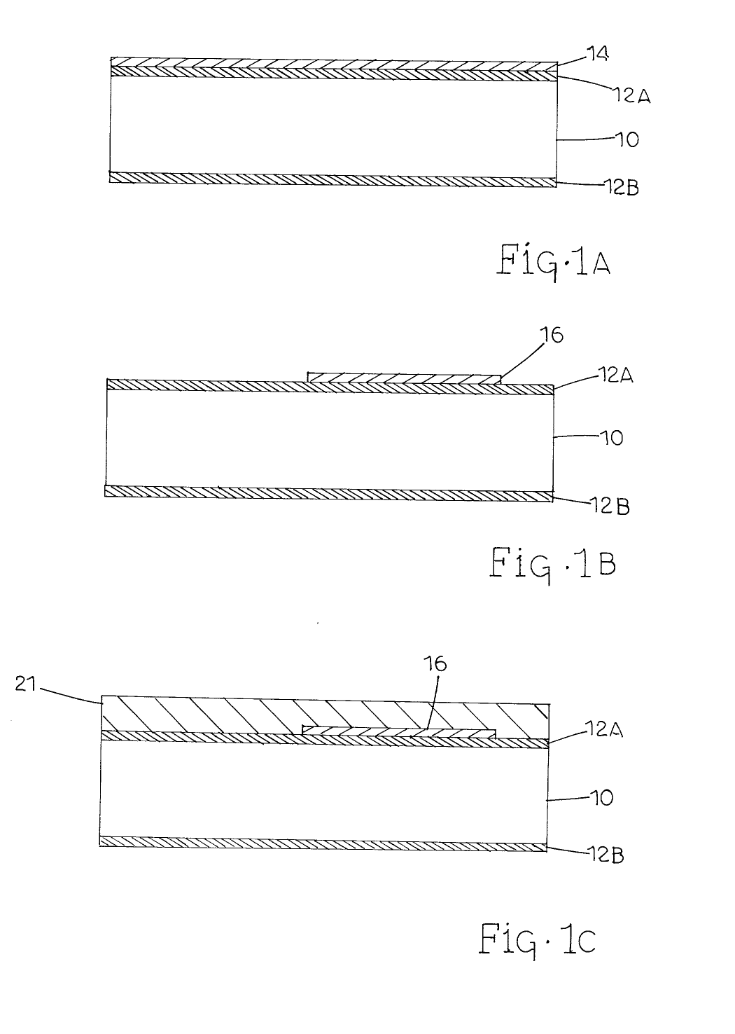

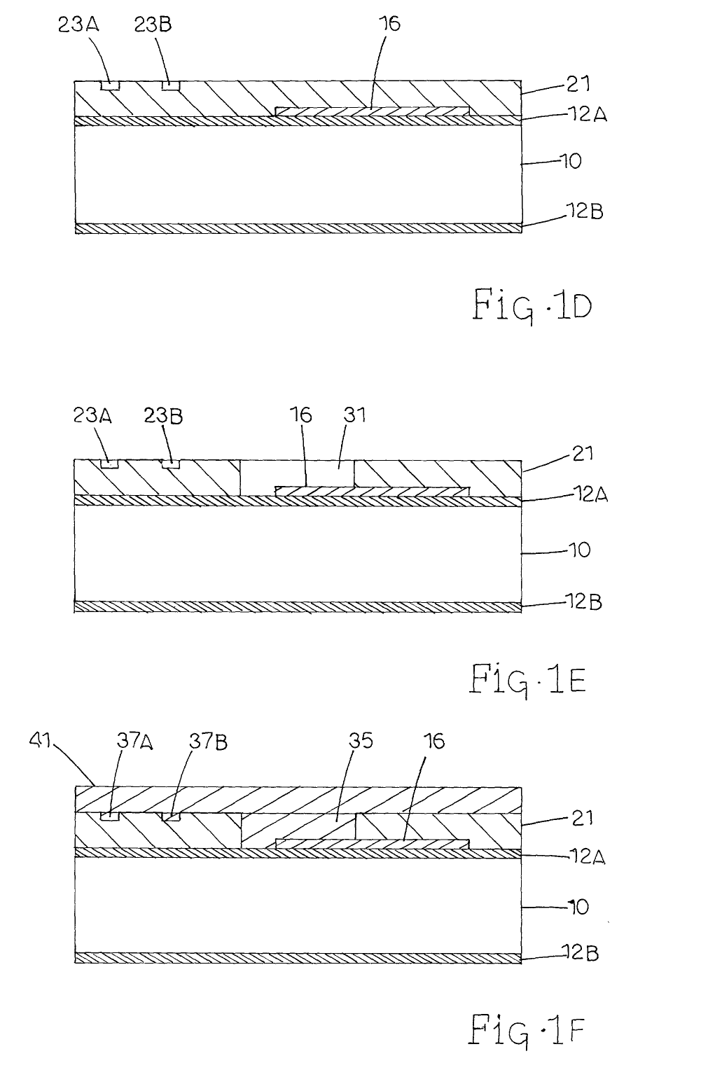

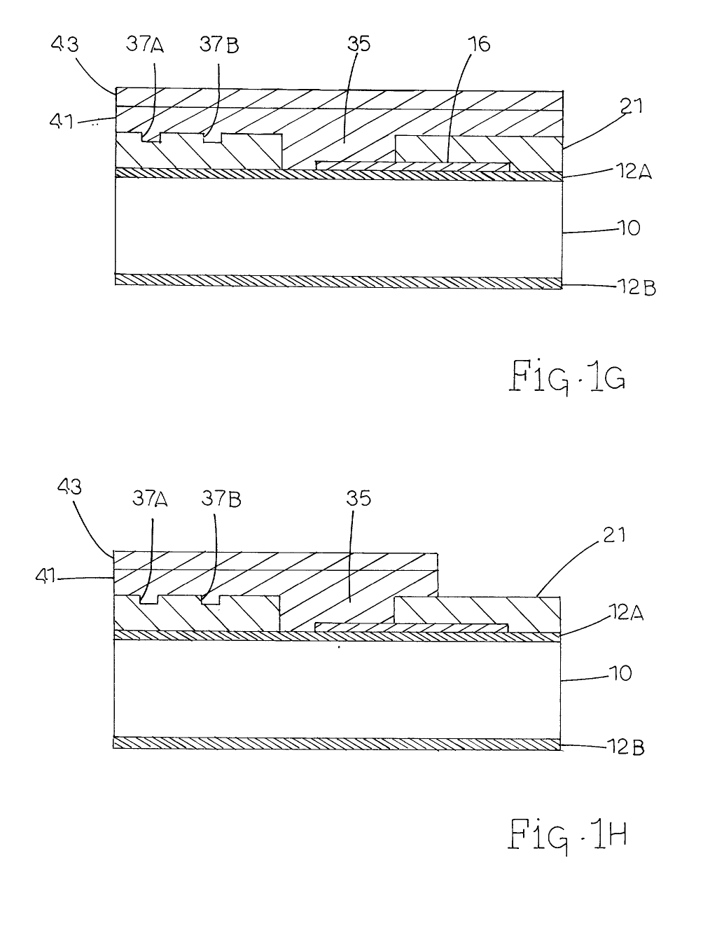

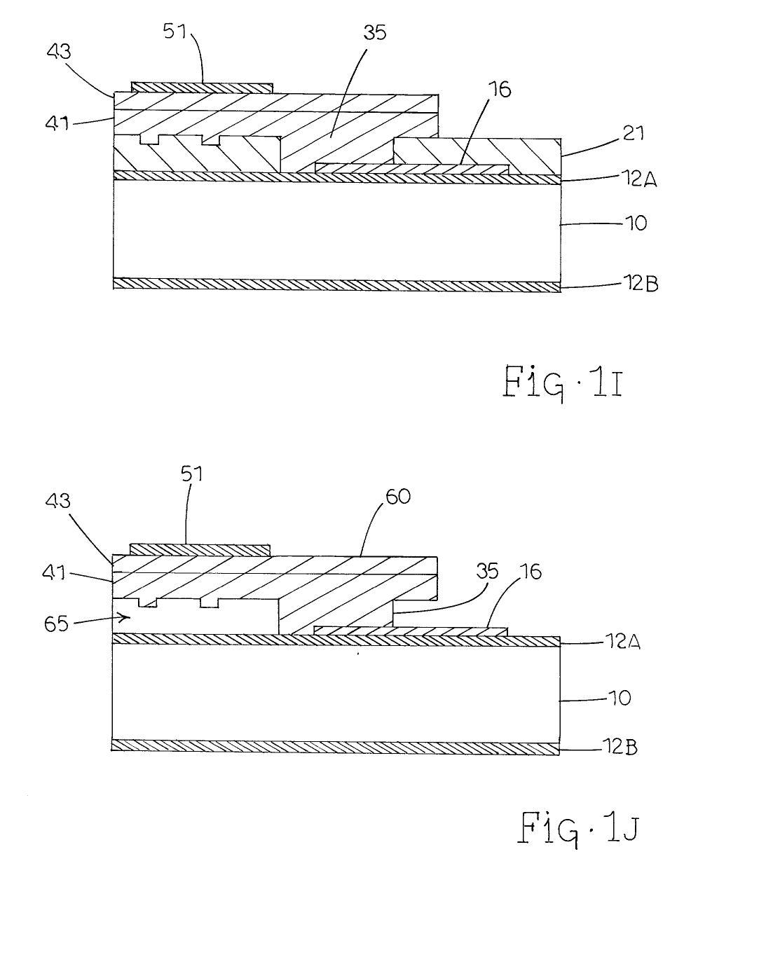

Referring now to FIGS. 1A-1J, a method for fabricating a through-wafer optical MEMS device according to a surface micromachining process of the present invention will now be described. Referring specifically to FIG. 1A, a starting wafer or substrate 10 is provided. Non-limiting examples of materials for use as starting substrate 10 include silicon (in single-crystal, polycrystalline, or amorphous forms), silicon oxinitride, glass, quartz, sapphire, zinc oxide, alumina, silica, or one of the various Group III-V compounds in either binary, ternary or quaternary forms (e.g., GaAs, InP, GaN, AlN, AlGaN, InGaAs, and so on). The choice of material for substrate 10 will depend in part on the desired optical wavelength selectivity. If the composition of starting substrate 10 is chosen to be silicon, preferably the top surface of substrate 10 should be heavily doped at the beginning of the fabrication process, or at least portions of the top surface where electrical contacts or conductive regions are desired. An anti-reflective coating 12A is deposited on substrate 10. Preferably, two anti-reflective coatings 12A and 12B are respectively deposited on both major surfaces of substrate 10. The composition and thickness of anti-reflective coatings 12A and 12B are selected such that they are compatible with the remaining fabrication process and are suitable to act as anti-reflective coatings in the desired wavelength range. For example, in the case of a silicon substrate, silicon nitride would be appropriate anti-reflective coating, where its thickness depends on the wavelength used. Next, a conductive layer 14 is deposited on anti-reflective coating layer 12A. Conductive layer 14 can be composed of polysilicon, or a metal if the remaining process is to be executed at low temperatures. Referring to FIG. 1B, a photolithographic technique is performed, and conductive layer 14 is patterned so as to form an interconnect 16.

Referring to FIG. 1C, a sacrificial layer 21 is deposited on anti-reflective coating 12A and interconnect 16. Non-limiting examples of the composition of sacrificial layer 21 include PSG, photosensitive polymer, or electroplated metal. Preferably, sacrificial layer 21 is deposited to a uniform thickness such that its top surface is planarized.

Referring to FIG. 1D, a second photolithographic technique and patterning step are performed so as to form dimples or recesses 23A and 23B in sacrificial layer 21. Referring to FIG. 1E, a third photolithographic technique and patterning step are performed to define an anchor area 31. If electroplated metal is used as sacrificial layer 21, the patterning of the photoresist used to define anchor area 31 is performed prior to deposition of sacrificial layer 21.

Referring to FIG. 1F, a structural material is deposited to fill in anchor area 31 and thus form an anchor portion 35, to fill in dimples 23A and 23B and thus respectively form bumps or standoff features 37A and 37B, and to form a blanket structural layer 41. Standoff features 37A and 37B are useful for preventing stiction of the structural material to substrate 10 during subsequent processing steps. Depending on the methodology used to actuate the microstructure to be formed, standoff features 37A and 37B can also be useful for preventing the microstructure from being pulled into contact with a conductive portion of substrate 10 and causing an electrical short. Non-limiting examples of suitable compositions for the structural material include polysilicon, and electroplated, evaporated or sputtered metal. Because it is desirable that the structural material be electrically conductive, if undoped polysilicon is deposited in this step, it is preferable that such polysilicon layer be doped by the deposition of a temporary layer of PSG on top of the structural material, followed by annealing at elevated temperatures and stripping of the doped layer afterwards.

Referring to FIG. 1G, an additional blanket layer 43 of the structural material can be deposited in order to increase the overall thickness of the structural material and to increase the out-of-plane thickness of the micromachined structure to be formed. Again, if second structural layer 43 is composed of undoped silicon, a doping step is preferably performed as described above. Referring to FIG. 1H, a fourth photolithographic technique is performed, and portions of structural layers 41 and 43 are removed down to sacrificial layer 21.

Referring to FIG. 11, additional photolithography is performed so as to form a metal element 51 on top of second structural layer 43 (or on first structural layer 41 if second structural layer 43 is absent). Preferably, metal element 51 is composed of gold with an adhesion layer such as chromium, titanium, or a suitable alloy such as titanium-tungsten, and is deposited by lift-off patterning. The photoresist material used in this step and the unwanted metal are then removed.

Referring to FIG. 1J, sacrificial layer 21 is removed to release structural layers 41 and 43 from substrate 10, thereby forming a movable, actuatable microstructure 60 such as an optical shutter that is anchored by anchor portion 35 to substrate 10 and freely suspended over substrate 10 by a gap generally designated 65. Metal element 51 is preferably used as a reflecting surface, and thus is disposed on the top surface of microstructure 60 at a location where it can intercept an optical signal transmitted along a path directed through gap 65 and the thickness of anti-reflective coatings and substrate 10. At this point, the basic process for fabricating an optical MEMS device, generally designated 80, is complete, with the fabrication of anti-reflective coatings 12A and 12B having been an integral step of the process.

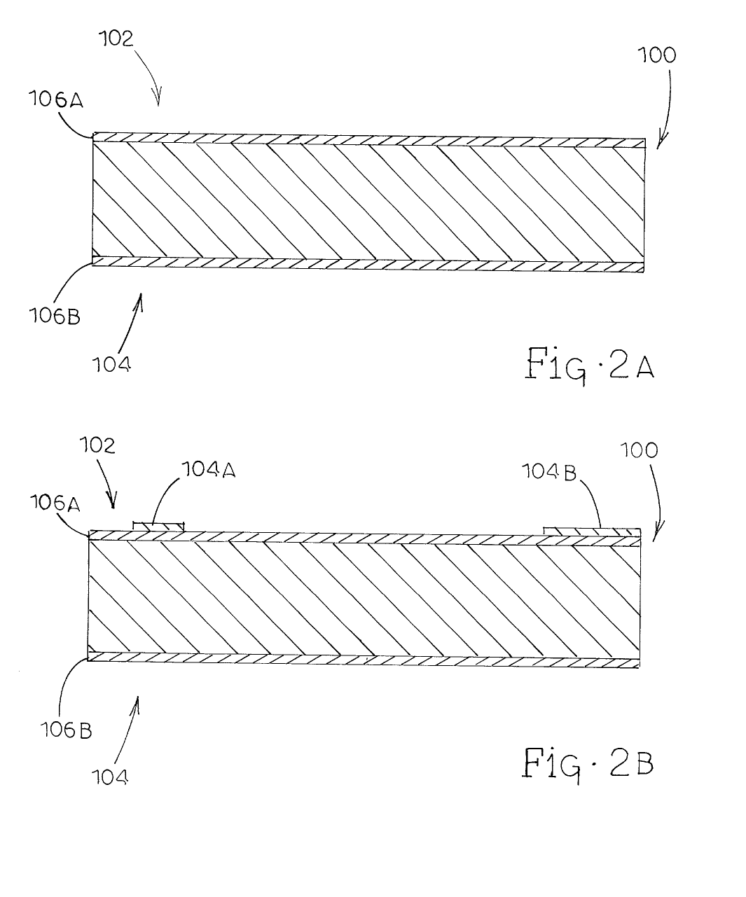

Referring now to FIGS. 2A-4, a method for fabricating a through-wafer optical MEMS device according to a bulk micromachining process will now be described. Referring specifically to FIG. 2A, a first substrate, generally designated 100, is provided as a starting material, and has a first side, generally designated 102, and a second side, generally designated 104. First substrate 100 can be composed of, for example, glass, silicon, silica, gallium arsenide, or other appropriate material. First and second anti-reflective layers 106A and 106B are respectively deposited on first and second sides 102 and 104 of first substrate 100. The material selected for anti-reflective layers 106A and 106B is selected so as to be compatible with the remaining fabrication process and to be functional in the desired wavelength range of incident light. Referring to FIG. 2B, a conductive layer is then deposited on first anti-reflective layer 106A and patterned using a conventional photolithography technique to form one or more interconnects 104A and 104B. Gold is an example of a suitable material for use as the conductive layer, although other metals could be used. For each interconnect 104A and 104B so formed, an adhesion layer can be applied if necessary or desired.

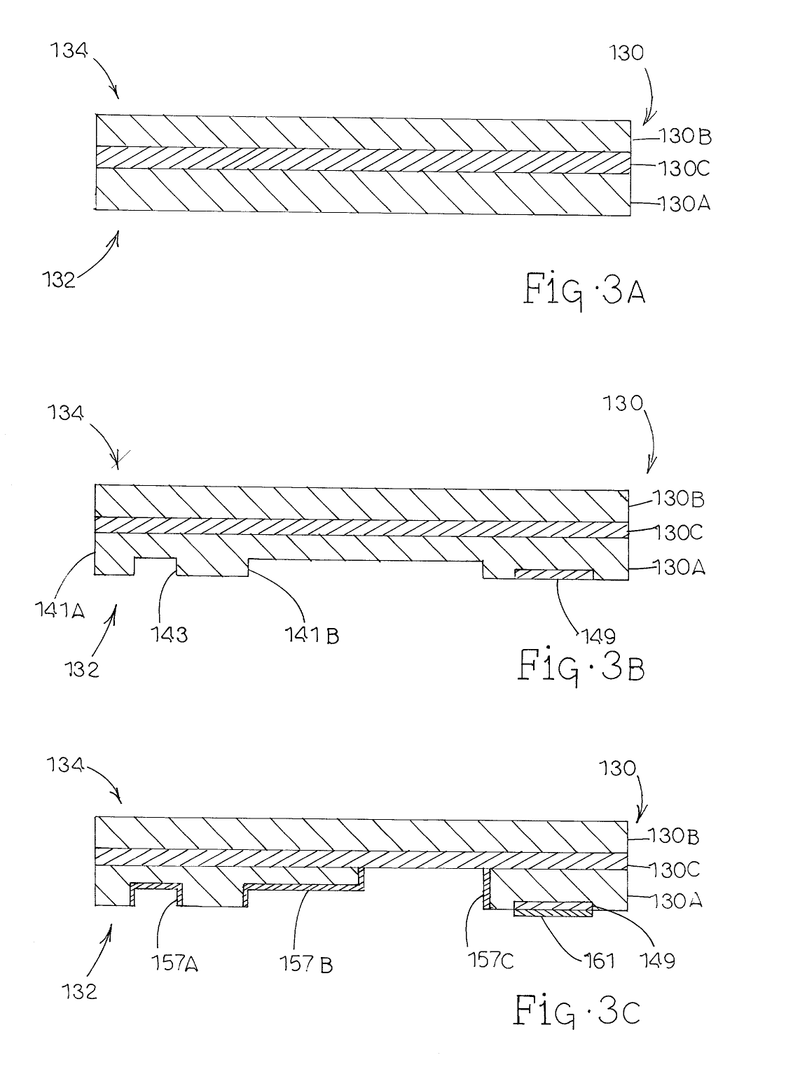

Referring to FIG. 3A, a second substrate, generally designated 130, is provided to serve as the starting wafer from which one or more movable microstructures are formed. Second substrate 130 has a first side, generally designated 132, and a second side, generally designated 134. Preferably, second substrate 130 is a silicon-on-insulator (SOI) or a silicon substrate/oxide/epitaxial silicon layer heterostructure, or some other suitable starting material that includes a buried or built-in etch-stop layer 130C between first and second bulk layers 130A and 130B. As another alternative, first and second bulk layers 130A and 130B could be fusion bonded together, using etch-stop layer 130C as the interface material. A masking layer of a dielectric material of suitable composition is deposited or otherwise formed on at least the outer surface of first bulk layer 130A of second substrate. One example of a suitable dielectric masking material is a nitride such as silicon nitride deposited by low-pressure or plasma-enhanced chemical vapor deposition. Another example is an oxide such as silicon oxide formed by thermal oxidation. The masking layer is patterned using a photolithographic mask. The patterning step could entail, for example, a dry etching technique such as plasma etching. In the case where the masking layer is silicon oxide, a reactive ion etching technique is preferred in this patterning step.

Referring to FIG. 3B, another etching step is then performed through the windows or openings defined by the mask to form first and second pedestals 141A and 141B, an interconnect channel 143 between first and second pedestals 141A and 141B, and a cavity 145. Wet or dry etching can be employed. Preferably, an anisotropic etching technique is selected for this step. In the case where oxide masks are formed, DRIE is preferred. The masking material is then removed. An additional masking layer is then formed from a suitable dielectric material such as an oxide or nitride. This new masking layer has a window through which a contact region 149 is defined in first bulk layer 130A of second substrate 130 by performing a doping step. Some examples of techniques for doping exposed area 47A include the ion implantation or diffusion of doping species originating from a solid source. Examples of suitable gases include an arsenic-containing gas (e.g., arsine) or a phosphorus-containing gas (e.g., phosphine) when n-type doping is desired, or a boron-containing gas (e.g., diborane) when p-type doping is desired. The masking material used for the doping step is then removed. Contact region 149 facilitates the formation of an ohmic contact.

Referring to FIG. 3C, a dielectric layer such as an oxide or nitride is conformally deposited on the exposed surfaces of first bulk layer 130A, and is patterned (such as by plasma etching) to serve as a masking layer for the subsequent etching of the microstructure. First bulk layer 130A of second substrate 130 is then etched, by as by DRIE, down to etch-stop layer 130C. The photoresist layer used in this etching step is then stripped. Another dielectric layer is then conformally deposited on the exposed surfaces of the first bulk layer 130A. One example of a suitable dielectric material is a nitride, such as silicon nitride, that is deposited by low-pressure chemical vapor deposition. The dielectric layer is then patterned to define dielectric portions 157A, 157B and 157C, thereby exposing a portion of etch-stop layer 130C and the outermost surfaces first bulk layer 130 that will serve as bonding areas in a subsequent bonding step described hereinbelow. When fabricating a microstructure from second substrate 130 in the form of an electrostatically actuated optical shutter, dielectric portions 157A, 157B and 157C can provide not only dielectric isolation, but also electrostatic force enhancement and pull-in voltage reduction. An additional photolithography is performed, and a metal layer is deposited and patterned so as to form a conductive contact 161 on contact region 149. The composition of metal contact 161 is preferably gold, but could also be silver, copper, or aluminum, with an adhesive layer if needed or desired.

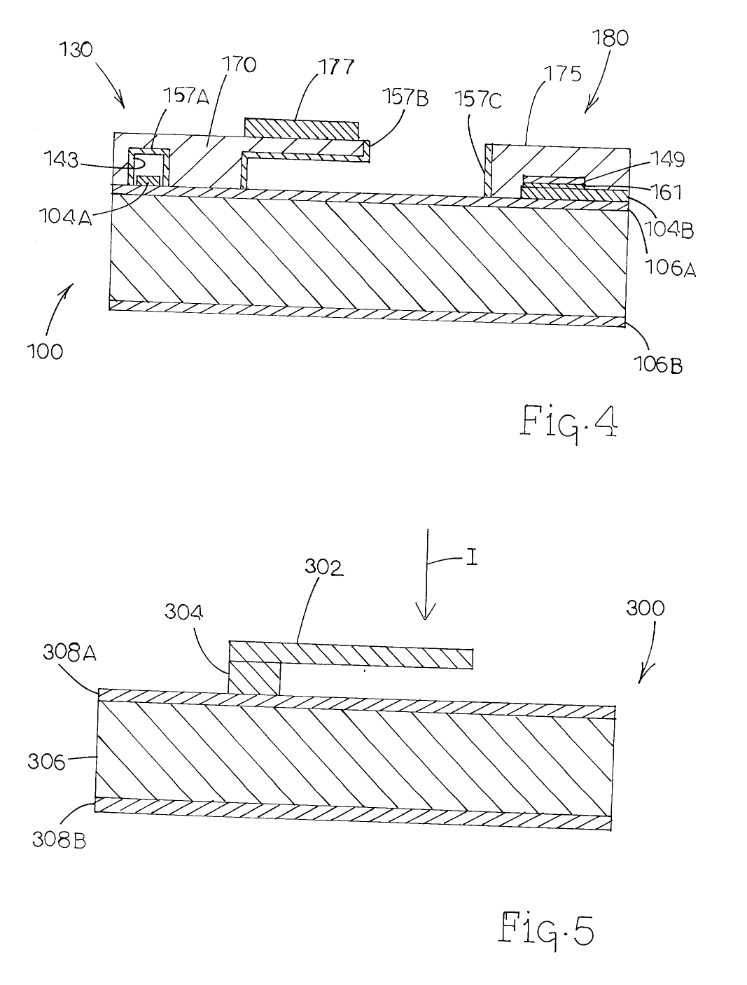

Referring now to FIG. 4, first side 102 of first substrate 100 is bonded to first side 132 of second substrate 130 by a suitable bonding technique such as anodic bonding, fusion bonding, glass-frit bonding, eutectic bonding, or adhesive bonding. The particular bonding technique selected will depend in part on the respective compositions of first and second substrates 100 and 130. As a result of this bonding step, interconnect 104A is electrically isolated in interconnect channel 143 by dielectric portion 157A, while dielectric portions 157B and 157C isolate the sidewalls of second substrate 130. In addition, interconnect 104B electrically communicates with contact 161. Bulk layer 130B of second substrate 130 is removed by etching, using an etchant such as KOH. Etch-stop layer 130C is removed by etching, thereby forming an actuatable, movable microstructure 170, such as an optical shutter, from second substrate 130 that is released from an electrode portion 175 of second substrate 130. Examples of suitable etchants include HF in the case where second substrate 130 was provided as an SOI wafer, and acetic acid:nitric acid:HF (8:3:1) in the case where second substrate 130 was provided as an n⁻ Si/p⁺ etch-stop/n⁻ Si stacked heterostructure. Masking, deposition, and etching steps are performed to form a metal (e.g., gold) element 177 on microstructure 170. Preferably, antireflection coating 106A is patterned (not specifically shown) such that it exists only under the actuatable portion of microstructure 170, i.e., in the path of the optical signal, and not at the areas on first substrate 100 where bonding to second substrate 130 is effected. At this point, the basic process for fabricating an optical MEMS device, generally designated 180, is complete, with the fabrication of antireflective coatings 106A and 106B having been an integral step of the process.

The structural material constituting respective microstructures 60 and 170 of optical MEMS devices 80 and 180 is semiconductive or conductive, and thus can be energized to effect movements of microstructures 60 and 170 so as to interact with an optical signal directed through the anti-reflective coatings and the base substrate of these devices 80 and 180. The interaction can include attenuation of the signal and/or a full ON/OFF switching function. Attenuation or full blocking of the signal can be effected by either absorbance or reflection. Metal element 51 or 177 disposed on the top surface of microstructure 60 or 170 can serve as a mirror for reflection of an optical signal. Depending on the specific actuating method to be integrated into optical MEMS device 80 or 180, the movement of microstructure 60 or 170 could be either in-plane or out-of-plane. Interconnect 104B of device 180 communicates with contact 161, with contact region 149 facilitating the ohmic contact, so as to define an actuation electrode that can be used to drive the movement of microstructure 170 by electrostatic force. Conformally deposited dielectric portions 157A, 157B, and 157C serve to isolate microstucture 170, electrode portion 175, and interconnect 104A from each other, and thus prevent shorting or shunting during actuation. Interconnect 104A is fully isolated in interconnect channel 143, and thus can function independently of microstructure 170, such as by serving as a conductor to some other element of the wafer assembly upon which microstructure 170 is formed.

Referring now to FIG. 5, by way of example, a simplified illustration is made of an optical MEMS device, generally designated 300, that can be fabricated based on any of the methods described hereinabove. A microstructure comprising one or more optical shutters 302 is formed from a substrate, bulk layer or film 304, such that each shutter 302 is anchored to a substrate 306. One or more anti-reflective coatings 308A and 308B are formed on substrate 306. Each shutter 302 is freely suspended over substrate 306, and is movable by way of a suitable actuation assembly (not shown) and conductive elements built into optical MEMS device 300 such as those described hereinabove. Shutters 302 can be implemented as switches to selectively block or pass incident light I through anti-reflective coatings 308A and 308B and substrate 306, or as variable optical attenuators (VOAs) to attenuate such light 1. As described hereinabove, a reflective element can be added to the surface of each shutter 302 provided to block or attenuate light by means of reflection. In other cases, the material of shutter 302 serves to absorb light, or a thin film of known composition and optical properties is added to the surface of shutter 302 for this purpose.

In general, the actuation of shutters or other movable microstructures entails alternately displacing the shutter of a portion thereof out of the optical path to allow light to pass, and moving the shutter back into the optical path to interfere with the optical path. As appreciated by persons skilled in the art, the particular kinematics characterizing the shutter movement depends in part on the design of the actuation assembly that is integrated with the optical MEMS device. For instance, the shutter can translate either in-plane or out-of-plane. An example of in-plane movement is the translation of the shutter along a direction parallel with a linear array of apertures. Another example is the translation of the shutter along a direction perpendicular to the array of apertures. Yet another example is the translation of the shutter along an arcuate path. An example of out-of-plane movement is the rotation of the shutter about an axis parallel with the array of apertures. Another example is the rotation of the shutter about an axis perpendicular with the array of apertures. Such axes of rotation can be realized by, for example, a kinematic joint or a compliant, torsional hinge. Yet another example is the out-of-plane deflection (i.e., bending or curling) of the shutter, in which case the shutter is a bi-material composite with inherent residual stress and elastic mismatches.

As also appreciated by persons skilled in the art, a number of actuation modes are available for the above-described shutter kinematics. Electrostatic, thermal, and magnetic energy mechanisms can be utilized to implement in-plane parallel and perpendicular shutter movement. Electrostatic actuation can be implemented by means of comb drive, variable gap parallel-plate, variable area parallel-plate, or scratch drive designs. Thermal actuation can be implemented by means of a bent beam mechanism or pairs of geometric, thermally-mismatched structures. Magnetic actuation can be implemented by providing a coil on the shutter or a fixed coil on the substrate, both with an external magnetic field.

Electrostatic, thermal, and magnetic energy mechanisms can similarly be utilized to implement in-plane rotational shutter movement. Suitable electrostatic actuation designs include lateral zippers, angular comb drives, angular scratch drives, and variable gap parallel-plate designs. Thermal designs include the use of geometric thermal mismatched structures and offset antagonistic actuators relying on thermal expansion. Magnetic designs generally entail using a magnetic shutter and an external magnetic field.

Electrostatic, thermal, and magnetic energy mechanisms can also be utilized to implement out-of-plane rotational shutter movement. Electrostatic comb and scratch drives, as well as geometric thermal mismatch structures can be used, but in conjunction with appropriate linkages, pivots and pop-up levers to achieve the desired out-of-plane motion. Another suitable design effect thermal deformation of a polyimide joint attached to the shutter. Out-of-plane shutter motion can also be accomplished using an electromagnetic coil on the shutter in conjunction with an external magnetic field.

For shutters that are actuated by causing them to curl out-of-plane, electrostatic, thermal, magnetic, and piezoelectric energy mechanisms can be utilized. Parallel-plate electrostatic actuation can be used to pull an initially curled cantilever-type, bi-material shutter down to the substrate. The initial curl in the shutter is accomplished by taking advantage of residual film stresses in a bi-material shutter, or by plastically deforming the shutter through thermal heating. In a similar manner, an initially curled bimetallic shutter of cantilever beam design can be driven down to the substrate by taking advantage of Joule heating of the bimetallic layers. A cantilever beam made from a shape memory alloy (SMA) material could also be made to lay flat or curl out-of-plane by inducing Joule heating. Magnetic actuation can be used to pull an initially curled cantilever beam towards or away from the substrate through the interaction of an electromagnetic coil or magnetic material on the beam and an external magnetic field. Piezoelectric actuation can be used to control the curvature of a cantilever beam by taking advantage of the expansion of a piezoelectric material in a bimetallic system.

In addition, in-plane free shutter rotation can be achieved with electrostatics through the use of a stepper motor driven by a ratchet mechanism, and angular comb drive, or a rotary micromotor design with sidewall or substrate electrodes. The ratchet mechanism used to actuate the stepper motor can be driven by geometric, thermal mismatched structural pairs. The foregoing actuation methodologies are generally known to persons skilled in the art.

The substrates used to form optical apertures and microstructures according to the invention can be any size suitable for carrying out bulk micromachining processes. An example of a suitably sized starting wafer is approximately 100 mm in diameter and approximately 500 microns in thickness (or height).

The optical MEMS devices produced in accordance with the invention can be encapsulated or sealed in a suitable packaging process.

It will be understood that various details of the invention may be changed without departing from the scope of the invention. Furthermore, the foregoing description is for the purpose of illustration only, and not for the purpose of limitation-the invention being defined by the claims.

What is claimed is:

1. A method for fabricating an optical MEMS device comprising the steps of:
(a) providing an optically transmissive substrate;
(b) depositing an antireflective coating on a surface of the substrate to enable an optical signal to be transmitted along a path directed through the antireflective coating and the substrate; and
(c) forming a movable, actuatable microstructure on the substrate, whereby actuation of the microstructure causes the microstructure to interact with the optical signal.

2. The method according to claim 1 wherein the substrate is composed of a material selected from the group consisting of silicon, silica, glass, quartz, sapphire, zinc oxide, alumina, Group III-V compounds, and alloys thereof.

3. The method according to claim 1 comprising the step of depositing a second antireflective coating on a second opposing surface of the substrate.

4. The method according to claim 1 comprising the step of forming a conductive element on the substrate.

5. The method according to claim 1 wherein the step of forming the microstructure comprises forming a patterned sacrificial layer on the substrate wherein at least a portion of the substrate is exposed, forming a structural layer on the sacrificial layer and on the exposed portion of the substrate, and removing at least a portion of the sacrificial layer to render the microstructure movable.

6. The method according to claim 1 comprising the step of forming an optically reflective element on the microstructure.

7. An optical MEMS device fabricated according to the method of claim 1.

8. A method for fabricating an optical MEMS device comprising the steps of:
(a) providing a first substrate composed of an optically transmissive material;
(b) depositing an antireflective coating on a surface of the first substrate to enable an optical signal to be transmitted along a path directed through the antireflective coating and the first substrate;
(c) forming a movable, actuatable microstructure on a second substrate; and
(d) bonding the second substrate to the first substrate, whereby the first and second substrates are aligned to enable the microstructure to interact with the optical signal upon actuation of the microstructure.

9. The method according to claim 8 wherein the substrate is composed of a material selected from the group consisting of silicon, silica, glass, quartz, sapphire, zinc oxide, alumina, Group Ill-V compounds, and alloys thereof.

10. The method according to claim 8 comprising the step of depositing a second antireflective coating on a second opposing surface of the first substrate.

11. The method according to claim 8 comprising the step of forming a conductive element on the first substrate.

12. The method according to claim 11 comprising the step of forming a channel in the second substrate whereby, after the bonding step, the conductive element formed on the first substrate is electrically isolated.

13. The method according to claim 8 wherein the second substrate comprises an etch-stop layer interposed between first and second bulk layers.

14. The method according to claim 13 comprising the step of removing at least a portion of the etch-stop layer to render the microstructure movable.

15. The method according to claim 8 comprising the step of doping a conductive region of the second substrate to enhance electrical conductivity of the conductive region.

16. The method according to claim 15 comprising the steps of forming a first contact on the second substrate in communication with the conductive region, and forming a second contact on the first substrate whereby, after the bonding step, the first contact communicates with the second contact.

17. The method according to claim 8 comprising the step of forming an optically reflective element on the microstructure.

18. The method according to claim 8 wherein the step of bonding comprises the step of performing a bonding technique selected from the group consisting of anodic bonding, fusion bonding, glass-frit bonding, eutectic bonding, and adhesive bonding.

19. An optical MEMS device fabricated according to the method of claim 8.
